(19) United States
(12) Patent Application Publication
(10) Pub. No.: US 2023/0357548 A1
(43) Pub. Date: Nov. 9, 2023

(54) Foam of polymers comprising an ethylene-vinyl acetate (EVA) copolymer and/or a copolymer of ethylene and of alkyl (meth)acrylate and a copolymer containing polyamide blocks and polyether blocks

(71) Applicant: ARKEMA FRANCE, Colombes (FR)

(72) Inventors: Blandine TESTUD, Serquigny (FR); Sébastien QUINEBECHE, Serquigny (FR); Chao-Ting CHANG, TAIPEI (TW); Clio COCQUET, Colombes Cedex (FR)

(73) Assignee: ARKEMA FRANCE, Colombes (FR)

(21) Appl. No.: 18/245,242

(22) PCT Filed: Sep. 15, 2021
(86) PCT No.: PCT/FR2021/051577

§ 371 Date: Mar. 14, 2023

(30) Foreign Application Priority Data
Sep. 15, 2020 (FR) FR2009341

(51) Int. Cl. C08L 23/08; C08J 9/00; C08J 9/10

(52) U.S. Cl. CPC C08L 23/0853; C08J 9/0061; C08J 9/0023; C08J 9/103; C08J 2323/08; C08J 2471/02; C08J 2477/00; C08J 2201/026

(57) ABSTRACT

The present invention relates to a foam of polymers comprising an ethylene-vinyl acetate (EVA) copolymer and/or a copolymer of ethylene and of alkyl (meth)acrylate and a copolymer containing polyamide blocks and polyether blocks (PEBA). The present invention also relates to a process for producing such a foam and also to the use of said foam, in particular in shoes.

### FIELD OF THE INVENTION

The present invention relates to a foam of polymers comprising an ethylene-vinyl acetate (EVA) copolymer and/or a copolymer of ethylene and of alkyl (meth)acrylate and a copolymer containing polyamide blocks and polyether blocks (PEBA). The present invention also relates to a process for producing such a foam and also to the use of said foam, in particular in shoes.

### TECHNICAL BACKGROUND

Various foams based on EVA copolymers are used notably in the field of sports equipment, such as soles or sole components, gloves, rackets or golf balls, personal protection items in particular for practising sports (jackets, interior parts of helmets, shells, etc.). Such applications require a set of particular physical properties which ensure rebound capacity, a low compression set and a capacity for enduring repeated impacts without becoming deformed and for returning to the initial shape.

There are a large number of EVA foams developed with chemical foaming agents for applications in shoes. However, these EVA foams have limitations in terms of flexibility, resilience, a relatively narrow working temperature range, and also relatively low drawability, and durability that is not ideal. In addition, these foams suffer from a great deal of shrinkage regardless of the process used to obtain them.

The document WO 2013/192581 describes an EVA foam comprising a polyolefin elastomer and an olefin block copolymer.

The document US2017/0267849 describes a pre-foam composition comprising a partially hydrogenated thermoplastic elastomeric block copolymer, an olefin block copolymer and an EVA. The partially hydrogenated thermoplastic elastomeric block copolymer is an A-B-A or A-B copolymer in which the A block comprises the styrene units and the B block is a random copolymer of ethylene and olefin.

However, it proves difficult to obtain a foam which combines the properties of a low density and good resilience. This is because, in general, an improvement of the mechanical properties is observed accompanying an increase in the density, or, vice versa, a reduction in density negatively affects the mechanical properties, in particular the resilience.

There is a need to provide lighter polymer foams having reduced shrinkage after shaping of the foam, and/or having a better resilience while at the same time retaining good stiffness.

### SUMMARY OF THE INVENTION

The invention relates first to a foam, typically a crosslinked foam, comprising:
a copolymer (a) chosen from an ethylene-vinyl acetate (EVA) copolymer, a copolymer of ethylene and of alkyl (meth)acrylate and/or mixtures thereof, and
a copolymer (b) containing polyamide blocks and polyether blocks (PEBA copolymer), said foam having a density of less than or equal to 200 kg/m³, preferably of less than or equal to 180 kg/m³, and/or a rebound resilience, according to the standard ISO 8307:2007, of greater than or equal to 50%, preferably of greater than or equal to 55%.

According to one embodiment, the foam comprises from 30% to 99.9%, typically from 55% to 99.9%, preferably from 60% to 99.9%, more preferentially from 70% to 99%, by weight of the copolymer (a) relative to the total weight of the foam.

According to one embodiment, the foam comprises from 0.1% to 50%, preferably from 0.1% to 40%, by weight of the PEBA copolymer (b), relative to the total weight of the foam. Preferably, the foam comprises from 0.1% to 30%, or from 0.5% to 30%, or from 1% to 25%, or from 1% to 20%, by weight of the PEBA copolymer (b), relative to the total weight of the foam.

According to one embodiment, the foam comprises from 0.1% to 20% by weight of additives, relative to the total weight of the foam.

According to one embodiment, the foam of the present invention can additionally comprise a polyolefin (c) and/or a thermoplastic elastomeric polymer (d).

According to one embodiment, the foam, typically a crosslinked foam, comprises:
from 30% to 99.9%, typically from 50% to 99.9%, preferably from 60% to 99.9%, more preferentially from 70% to 99%, by weight of a copolymer (a) chosen from an ethylene-vinyl acetate (EVA) copolymer, a copolymer of ethylene and of alkyl (meth)acrylate and/or mixtures thereof, and
from 0.1% to 40%, preferably from 0.1% to 30%, by weight of a copolymer (b) containing polyamide blocks and polyether blocks (PEBA copolymer),
from 0% to 50% by weight of a polyolefin (c) and/or a thermoplastic elastomeric polymer (d);
the total amounting to 100% by weight of the foam;
said foam having a density of less than or equal to 200 kg/m³, preferably of less than or equal to 180 kg/m³, and/or a rebound resilience, according to the standard ISO 8307:2007, of greater than or equal to 50%, preferably of greater than or equal to 55%.

Preferably, the foam comprises from 0.1% to 50%, preferably from 0.1% to 40%, or 0.1% to 30%, or 0.1% to 20%, by weight, relative to the total weight of the foam, of a polyolefin (c) and/or a thermoplastic elastomeric polymer (d).

The polyolefin (c) can be functionalized or nonfunctionalized or be a mixture of at least one which is functionalized and/or at least one which is nonfunctionalized. The polyolefin (c) is preferably a functionalized polyolefin (c1).

The thermoplastic elastomeric polymer (d) can typically be chosen from a copolymer containing polyester blocks and polyether blocks, a polyurethane, an olefinic thermoplastic elastomer or an olefinic block copolymer, a styrene-diene block copolymer, and/or mixtures thereof.

The present invention makes it possible to meet the need expressed above.

It provides a foam which has improved foamability, has a low density, and has one or more advantageous properties from among: a high capacity for restoring elastic energy during low-stress loading; a low compression set (and hence improved durability); a high rebound resilience; and improved resilience properties.

This is accomplished by virtue of the introduction of the PEBA copolymer into a crosslinked foam of ethylene-vinyl acetate (EVA) and/or of ethylene and of alkyl (meth)acrylate.

The foam proposed by the present invention is particularly notable for the application in shoes, in particular sports shoes, by virtue of a low density, that is to say generally of less than 200 kg/m³, preferably of less than or equal to 150 kg/m³, possibly of down to 100 kg/m³, and a high rebound resilience, that is to say of greater than 50%, or even of greater than 60%.

The invention also relates to a process for preparing a foam as described above, comprising:
(i) a step of providing a mixture comprising:
   a copolymer (a),
   a copolymer (b),
   a crosslinking agent, preferably a peroxide,
   a foaming agent, preferably a chemical foaming agent,
   optionally a polyolefin (c), a thermoplastic elastomeric polymer (d), and at least one additive;
(ii) a step of shaping the mixture by injection moulding, compression/moulding or extrusion;
(iii) a step of foaming the mixture.

The above steps can be carried out separately or simultaneously.

According to one embodiment, steps (i)+(ii), (ii)+(iii) or (i)+(ii)+(iii) are carried out simultaneously.

The steps of the preparation process can be performed in the same item of equipment, for example in a mixer or an extruder.

According to one embodiment, step (i) is carried out by mixing, in the molten state:
from 30% to 99.9%, typically from 50% to 99.9%, preferably from 60% to 99.9%, by weight of the copolymer (a);
from 0.1% to 50%, typically from 0.1% to 40%, preferably from 0.1% to 30%, by weight of the PEBA copolymer (b);
from 0% to 50% by weight of the polyolefin (c) and/or the thermoplastic elastomeric polymer (d);
from 0% to 20%, preferably from 0.1% to 20%, by weight of at least one additive;
from 0.01% to 2% by weight of the crosslinking agent, preferably a peroxide;
from 0.5% to 10% by weight of the foaming agent, preferably a chemical foaming agent,
   the total amounting to 100% by weight of the mixture.

According to another variant, the foaming agent is introduced during and/or after step (ii). The amount of the foaming agent introduced into the process is typically from 0.5% to 10% by weight relative to the total weight of the mixture.

The invention also relates to a composition or a foam capable of being obtained according to the process described above.

The process of the invention makes it possible to prepare a polymer foam which is regular, homogeneous and has the above-mentioned advantageous properties.

Typically, the foam obtained at the end of the preparation process described above consists essentially, or even consists, of:
the (co)polymers forming a polymer matrix of the foam, and
the decomposition products and/or the byproducts generated from the at least one foaming agent and from the at least one crosslinking agent and optionally at least one additive, which are located dispersed in the polymer matrix.

The invention relates to the use of a foam as described above for the production of an article, preferably a shoe sole.

The invention also relates to an article consisting of or comprising at least one element of a foam as described above.

The article can be chosen from shoe soles, in particular sports shoe soles, large or small balls, gloves, personal protective equipment, rail pads, motor vehicle parts, construction parts and electrical and electronic equipment parts.

The invention will now be described in more detail.

### DETAILED DESCRIPTION

Copolymer (a)

The copolymer (a) according to the invention is a copolymer chosen from an ethylene-vinyl acetate (EVA) copolymer, a copolymer of ethylene and of alkyl (meth)acrylate and/or mixtures thereof.

The relative amount of vinyl acetate comonomer incorporated into the EVA copolymer can be from 0.1% by weight up to 40% by weight of the total copolymer, or even more. For example, the EVA may have a vinyl acetate content of from 2% to 50% by weight, 5% to 40% or 10% to 30% by weight. The EVA can be modified by processes well known to those skilled in the art, including modification with an unsaturated carboxylic acid or derivatives thereof, such as maleic anhydride or maleic acid.

The copolymer of ethylene and of alkyl (meth)acrylate comprises repeat units derived from ethylene and from alkyl acrylate, from alkyl methacrylate, or from combinations thereof, in which the alkyl fragment contains from 1 to 8 carbon atoms. Examples of alkyl include methyl, ethyl, propyl, butyl or combinations of two or more of these. The alkyl (meth)acrylate comonomer may be incorporated into the ethylene/alkyl (meth)acrylate copolymer in an amount of from 0.1% by weight to 45% by weight of the total copolymer, or even more. The alkyl group can contain 1 to around 8 carbon atoms. For example, the alkyl (meth)acrylate comonomer can be present in the copolymer in an amount of from 5% to 45%, 10% to 35% or 10% to 28% by weight. Examples of ethylene-alkyl (meth)acrylate copolymer include ethylene/methyl acrylate, ethylene/ethyl acrylate, ethylene/butyl acrylate, or combinations of two or more of these. A mixture of two or more different ethylene-alkyl (meth)acrylate copolymers can be used.

The copolymer (a) can have a melt flow index (MFI) of from 0.1 to 60 g/10 minutes, or from 0.3 to 30 g/10 minutes. Preferably, the copolymer (a) has a low melt flow index, for example from 0.1 to 20, or from 0.5 to 20, or 0.5 to 10, or from 0.1 to 5 g/10 minutes.

In the context of the invention, the melt flow indices (MFI) were measured at a temperature of 190° C. under a load of 2160 grams (units expressed in g/10 minutes) according to the standard ISO 1133, unless indicated otherwise.

Copolymer (b) Containing Polyamide Blocks and Polyether Blocks (PEBA)

The copolymer (b) of the present invention generally has an instantaneous hardness of less than or equal to 72 Shore D, more preferably less than or equal to 68 Shore D or to 55 Shore D or to 45 Shore D. The hardness measurements can be carried out according to the standard ISO 868:2003.

Three types of polyamide blocks may advantageously be used.

According to a first type, the polyamide blocks originate from the condensation of a dicarboxylic acid, in particular those containing from 4 to 36 carbon atoms, preferably those containing from 6 to 18 carbon atoms, and of a diamine, in particular those containing from 2 to 20 carbon atoms, preferably those containing from 5 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues, and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
   said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid.

As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by Croda, or under the brand name Empol by BASF, or under the brand name Radiacid by Oleon, and polyoxyalkylene α,ω-diacids. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, wherein 6.6 denotes hexamethylenediamine units condensed with adipic acid and 6 denotes units resulting from the condensation of caprolactam;
PA 6.6/6.10/11/12, wherein 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides wherein X, Y, Z, etc. represent homopolyamide units as described above.

As examples of copolyamides, mention may be made of copolymers of caprolactam and of lauryllactam (PA 6/12), copolymers of caprolactam, of adipic acid and of hexamethylenediamine (PA 6/66), copolymers of caprolactam, of lauryllactam, of adipic acid and of hexamethylenediamine (PA 6/12/66), copolymers of caprolactam, of lauryllactam, of 11-aminoundecanoic acid, of azelaic acid and of hexamethylenediamine (PA 6/69/11/12), copolymers of caprolactam, of lauryllactam, of 11-aminoundecanoic acid, of adipic acid and of hexamethylenediamine (PA 6/66/11/12), copolymers of lauryllactam, of azelaic acid and of hexamethylenediamine (PA 69/12), copolymers of 11-aminoundecanoic acid, of terephthalic acid and of decamethylenediamine (PA 11/10T).

Advantageously, the polyamide blocks of the copolymer used in the invention comprise polyamide blocks chosen from PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, PA6/12, PA11/12, PA11/10.10 or mixtures or copolymers thereof; and preferably comprise blocks of polyamide PA 6, PA 11, PA 12, PA 6.10, PA 10.10, PA 10.12, PA6/12, PA 11/12 or mixtures or copolymers thereof.

The polyether blocks of the PEBA copolymer are formed from alkylene oxide units. The polyether blocks can in particular be PEG (polyethylene glycol) blocks, i.e. blocks formed from ethylene oxide units, and/or PPG (polypropylene glycol) blocks, i.e. blocks formed from propylene oxide units, and/or PO3G (polytrimethylene glycol) blocks, i.e. blocks formed from trimethylene glycol ether units, and/or PTMG (polytetramethylene glycol) blocks, i.e. blocks formed from tetramethylene glycol units, also known as polytetrahydrofuran. The copolymers may comprise in their chain several types of polyethers, the copolyethers possibly being in block or random form.

Use may also be made of blocks obtained by oxyethylation of bisphenols, such as, for example, bisphenol A. The latter products are described in particular in the document EP 613919.

The polyether blocks may also be formed from ethoxylated primary amines. As examples of ethoxylated primary amines, mention may be made of the products of formula:

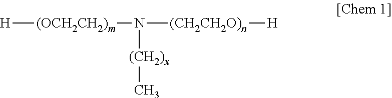

in which m and n are integers between 1 and 20 and x is an integer between 8 and 18. These products are for example commercially available under the brand name Noramox® from CECA and under the brand name Genamin® from Clariant.

The polyether blocks may comprise polyoxyalkylene blocks bearing NH₂ chain ends, such blocks being able to be obtained by cyanoacetylation of α,ω-dihydroxylated aliphatic polyoxyalkylene blocks known as polyether diols. More particularly, the commercial products Jeffamine or Elastamine may be used (for example Jeffamine® D400, D2000, ED 2003, XTJ 542, which are commercial products from Huntsman, also described in documents JP 2004346274, JP 2004352794 and EP 1482011).

The polyether diol blocks are either used in unmodified form and copolycondensed with polyamide blocks bearing carboxylic end groups, or are aminated to be converted into polyetherdiamines and condensed with polyamide blocks bearing carboxylic end groups.

While the PEBA copolymers above comprise at least one polyamide block and at least one polyether block as described above, the present invention also covers the copolymers comprising three, four (or even more) different blocks chosen from those described in the present description, for example; polyester blocks, polysiloxane blocks, such as polydimethylsiloxane (or PDMS) blocks, polyolefin blocks, polycarbonate blocks, and mixtures thereof. For example, the copolymer according to the invention can be a segmented block copolymer comprising three different types of blocks (or “triblock” copolymer), which results from the condensation of several of the blocks described above. Said triblock may for example be a copolymer comprising a polyamide block, a polyester block and a polyether block or a copolymer comprising a polyamide block and two different polyether blocks, for example a PEG block and a PTMG block.

PEBAs result from the polycondensation of polyamide blocks bearing reactive ends with polyether blocks bearing reactive ends, such as, inter alia, the polycondensation:
1) of polyamide blocks bearing diamine chain ends with polyoxyalkylene blocks bearing dicarboxylic chain ends;
2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyether diols;
3) of polyamide blocks bearing dicarboxylic chain ends with polyether diols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

PEBA copolymers that are particularly preferred in the context of the invention are copolymers including blocks from among: PA 11 and PEG; PA 11 and PTMG; PA 12 and PEG; PA 12 and PTMG; PA 6.10 and PEG; PA 6.10 and PTMG; PA 6 and PEG; PA 6 and PTMG, PA 6/12 and PTMG, PA 6/12 and PEG, PA11/12 and PTMG, PA 11/12 and PEG.

According to one embodiment, the PEBA copolymer is linear.

According to one embodiment, the number-average molar mass Mn of the polyamide blocks in the copolymer is preferably from 400 to 13 000 g/mol, more preferentially from 500 to 10 000 g/mol, even more preferentially from 600 to 9000 g/mol or between 600 and 6000 g/mol. In embodiments, the number-average molar mass of the polyamide blocks in the copolymer is from 400 to 500 g/mol, or from 500 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol.

The number-average molar mass of the polyether blocks is preferably from 100 to 3000 g/mol, preferably from 200 to 2000 g/mol. In embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of chain limiter in excess, MW_{repeating unit} represents the molar mass of the repeating unit, and MW_{chain limiter} represents the molar mass of the chain limiter in excess.

The number-average molar mass of the polyamide blocks and of the polyether blocks can be measured before the copolymerization of the blocks by gel permeation chromatography (GPC) according to the standard ISO 16014-1:2012 in tetrahydrofuran (THF).

The mass ratio of the polyamide blocks relative to the polyether blocks of the PEBA copolymer is typically from 0.1 to 20.

Preferably, the mass ratio of the polyamide blocks relative to the polyether blocks of the PEBA is from 0.3 to 5, more preferentially from 0.3 to 2.

In particular, the mass ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Polyolefin (c)

The foam can comprise a polyolefin (c) chosen from functionalized (c1) and nonfunctionalized (c2) polyolefins and mixtures thereof.

The polyolefin can typically have a flexural modulus of less than 100 MPa, measured according to the standard ISO 178, and a Tg of less than 0° C. (measured according to the standard 11357-2 at the inflection point of the DSC thermogram).

A nonfunctionalized polyolefin (c2) is conventionally a homopolymer or copolymer of alpha-olefins or of diolefins, such as, for example, ethylene, propylene, 1-butene, 1-octene or butadiene. Mention may be made, by way of example, of:
polyethylene homopolymers and copolymers, in particular LDPE, HDPE,

LLDPE (linear low density polyethylene), VLDPE (very low density polyethylene) and metallocene polyethylene,
propylene homopolymers or copolymers,
ethylene/alpha-olefin copolymers, such as ethylene/propylene, EPRs (abbreviation of ethylene-propylene rubbers) and ethylene/propylene/dienes (EPDMs).

The functionalized polyolefin (c1) may be a polymer of alpha-olefins having reactive units (functionalities); such reactive units are acid, anhydride or epoxy functions. Mention may be made, by way of example, of the preceding polyolefins (c2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized by metals such as Zn, etc.), or else with carboxylic acid anhydrides, such as maleic anhydride. A functionalized polyolefin is, for example, a PE/EPR mixture, the ratio by weight of which can vary within broad limits, for example between 40/60 and 90/10, said mixture being cografted with an anhydride, in particular maleic anhydride, according to a degree of grafting, for example, from 0.01% to 5% by weight.

The functionalized polyolefin (c1) can be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin copolymers, such as ethylene/propylene, EPRs (abbreviation of ethylene-propylene rubbers) and ethylene/propylene/dienes (EPDM5),
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (c1) can also be chosen from ethylene/propylene copolymers, predominant in propylene, grafted with maleic anhydride and then condensed with monoaminated polyamide (or polyamide oligomer) (products described in EP-A-0342066).

The functionalized polyolefin (c1) can also be a copolymer or terpolymer of at least the following units: (1) ethylene, (2) alkyl (meth)acrylate or saturated carboxylic acid vinyl ester and (3) anhydride such as maleic anhydride or (meth)acrylic acid or epoxy, such as glycidyl (meth)acrylate.

Mention may be made, as examples of functionalized polyolefins of the latter type, of the following copolymers, where ethylene preferably represents at least 60% by weight and where the termonomer (the functional group) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li. The term “alkyl (meth)acrylate” in (c1) or (c2) denotes C₁ to C₈ alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

The abovementioned copolymers, (c1) and (c2), can be copolymerized in random or block fashion and can exhibit a linear or branched structure.

The nonfunctionalized polyolefins (c2) are advantageously chosen from polypropylene homopolymers or copolymers, and any ethylene homopolymer, or copolymer of ethylene and of a comonomer of higher alpha-olefin type, such as butene, hexene, octene or 4-methyl-1-pentene. Mention may be made, for example, of PPs, high density PEs, medium density PEs, linear low density PEs, low density PEs or ultra low density PEs. These polyethylenes are known by a person skilled in the art to be produced according to a “radical” process, according to a “Ziegler” type catalysis or, more recently, according to a “metallocene” catalysis.

The functionalized polyolefins (c1) are advantageously chosen from any polymer comprising alpha-olefin units and units bearing polar reactive functions, such as epoxy, carboxylic acid or carboxylic acid anhydride functions. Mention may be made, as examples of such polymers, of terpolymers of ethylene, of alkyl acrylate and of maleic anhydride or of glycidyl methacrylate, such as the Lotader0 products, or polyolefins grafted with maleic anhydride, such as the Orevac® products, and also terpolymers of ethylene, of alkyl acrylate and of (meth)acrylic acid. Mention may also be made of homopolymers or copolymers of polypropylene grafted with a carboxylic acid anhydride and then condensed with polyamides or oligomers, which are monoaminated, of polyamide.

It has been observed that the functionalized polyolefin (c1) can improve the compatibility between the copolymer (a) and the copolymer (b).

According to one embodiment, the foam comprises from 0.1% to 50%, preferably 0.1% to 40%; or 0.1% to 30%, or 0.1% to 20%, by weight, relative to the total weight of the foam, of a polyolefin (c) as described above.

Thermoplastic Elastomeric Polymer (d)

According to one embodiment, the foam comprises from 0.1% to 50%, preferably 0.1% to 40%; or 0.1% to 30%, or 0.1% to 20%, by weight, relative to the total weight of the foam, of a thermoplastic elastomeric polymer (d) chosen from a copolymer containing polyester blocks and polyether blocks, a thermoplastic polyurethane, an olefinic thermoplastic elastomer or an olefinic block copolymer, a styrene-diene block copolymer, and/or mixtures thereof.

The copolymer containing polyester blocks and polyether blocks typically consists of flexible polyether blocks derived from polyether diols and of rigid polyester blocks which result from the reaction of at least one dicarboxylic acid with at least one chain-extending short diol unit. The polyester blocks and the polyether blocks are connected via ester bonds resulting from the reaction of the acid functions of the dicarboxylic acid with the hydroxyl functions of the polyether diol. The sequence of polyethers and of diacids forms the flexible blocks whereas the sequence of glycol or of butanediol with diacids forms the rigid blocks of the copolyetherester. The chain-extending short diol may be chosen from the group consisting of neopentyl glycol, cyclohexanedimethanol and aliphatic glycols of formula HO(CH2)nOH in which n is an integer ranging from 2 to 10.

Advantageously, the diacids are aromatic dicarboxylic acids containing from 8 to 14 carbon atoms. Up to 50 mol % of the aromatic dicarboxylic acid may be replaced with at least one other aromatic dicarboxylic acid containing from 8 to 14 carbon atoms, and/or up to 20 mol % may be replaced with an aliphatic dicarboxylic acid containing from 2 to 14 carbon atoms.

As examples of aromatic dicarboxylic acids, mention may be made of terephthalic acid, isophthalic acid, dibenzoic acid, naphthalenedicarboxylic acid, 4,4′-diphenylenedicarboxylic acid, bis(p-carboxyphenyl)methane acid, ethylenebis-p-benzoic acid, 1,4-tetramethylenebis(p-oxybenzoic acid), ethylenebis(p-oxybenzoic acid) and 1,3-trimethylenebis(p-oxybenzoic acid).

As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedim ethanol. The copolymers containing polyester blocks and polyether blocks are, for example, copolymers containing polyether units derived from polyether diols such as polyethylene glycol (PEG), polypropylene glycol (PPG), polytrimethylene glycol (PO3G) or polytetramethylene glycol (PTMG), dicarboxylic acid units such as terephthalic acid and glycol (ethanediol) or 1,4-butanediol units. Such copolyetheresters are described in patents EP 402 883 and EP 405 227. These polyetheresters are thermoplastic elastomers. They may contain plasticizers.

The thermoplastic polyurethanes are linear or slightly branched polymers consisting of hard blocks and flexible elastomeric blocks. They can be produced by reacting flexible elastomeric polyethers having a hydroxyl end group or polyesters with diisocyanates such as methylene diisocyanate or toluene diisocyanate. These polymers may be chain-extended with glycols, diamines, diacids or amino alcohols. The products of reaction of isocyanates and alcohols are urethanes and these blocks are relatively hard with a high melting point. These hard blocks with a high melting point are responsible for the thermoplastic nature of the polyurethanes.

The olefinic thermoplastic elastomer comprises repeat units of ethylene and of higher primary olefins such as propylene, hexene, octene or combinations of two or more of these and optionally of 1,4-hexadiene, ethylidenenorbornene, norbornadiene or combinations of two or more of these. The olefinic elastomer may be functionalized by grafting with an acid anhydride such as maleic anhydride.

The styrene-diene block copolymer comprises repeat units derived from polystyrene units and from polydiene units. The polydiene units are derived from polybutadiene, from polyisoprene units or from copolymers of the two. The copolymer may be hydrogenated to produce a saturated rubber backbone segment commonly known as styrene/butadiene/styrene (SBS) or styrene/isoprene/styrene (SIS) thermoplastic elastomers or styrene/ethylene-butene/styrene (SEBS) or styrene/ethylene-propylene/styrene (SEPS) block copolymers. They may also be functionalized by grafting with an acid anhydride such as maleic anhydride.

Additives

The foam may comprise from 0.1% to 20%, preferably from 0.1% to 15%, or from 0.1% to 12%, or from 0.1% to 10%, by weight, relative to the total weight of the foam, of additives.

The additives are typically customary additives used in foams which contribute to improving the properties of the foams and/or the foaming process.

Typically, the additives may be a pigment (TiO₂ and other compatible coloured pigments), dye, an adhesion promoter (for improving the adhesion of the expanded foam to other materials), organic or inorganic fillers (for example calcium carbonate, barium sulfate and/or silicon oxide), a reinforcing agent, plasticizers, a nucleating agent (in pure form or in concentrated form, for example CaCO₃, ZnO, SiO₂, or combinations of two or more of these, rubber (for improving the rubber elasticity, such as natural rubber, SBR, polybutadiene and/or ethylene propylene terpolymer), stabilizers, antioxidants, UV absorbers, flame retardants, carbon black, carbon nanotubes, a mould-release agent, impact-resistant agents, and additives for improving processibility (processing aids), for example stearic acid). The antioxidants may include phenolic antioxidants.

Process

The foam can be produced by a certain number of processes, such as compression moulding, injection moulding or hybrids of extrusion and moulding.

The process for preparing a crosslinked foam as defined above generally comprises:
(i) a step of providing a mixture comprising:
   a copolymer (a),
   at least one copolymer (b),
   a crosslinking agent, preferably a peroxide,
   a foaming agent, preferably a chemical foaming agent,
   optionally a polyolefin (c), a thermoplastic elastomeric polymer (d), and at least one additive;
(ii) a step of shaping the mixture by injection moulding, compression/moulding or extrusion;
(iii) a step of foaming the mixture.

According to one embodiment, step (i) is carried out by mixing, in the molten state:
from 30% to 99.9% by weight of the copolymer (a);
from 0.1% to 50%, preferably from 0.1% to 40%, by weight of the PEBA copolymer (b);
from 0% to 50% by weight of the polyolefin (c) and/or the thermoplastic elastomeric polymer (d);
from 0% to 20%, preferably from 0.1% to 20%, by weight of at least one additive;
0.01% to 2% by weight of the crosslinking agent, preferably a peroxide;
from 0.5% to 10% by weight of the foaming agent, preferably a chemical foaming agent,
   the total amounting to 100% by weight of the mixture.

A homogeneous molten mixture is obtained at the end of the mixing step.

According to one embodiment, from 0.01% to 2%, preferably from 0.05% to 2%, or from 0.05% to 1.8%, by weight of a crosslinking agent is introduced into the mixture.

In general, the crosslinking agent is chosen from an agent enabling the crosslinking of the EVA and/or of ethylene and of alkyl (meth)acrylate, possibly comprising one or more organic peroxides, for example chosen from dialkyl peroxides, peroxyesters, peroxydicarbonates, peroxyketals, diacyl peracids, or combinations of two or more of these. Examples of peroxides include dicumyl peroxide, di(3,3,5-trimethylhexanoyl) peroxide, t-butyl peroxypivalate, t-butyl peroxyneodecanoate, di(sec-butyl) peroxydicarbonate, t-amyl peroxyneodecanoate, 1,1-di-t-butylperoxy-3,3,5-trimethylcyclohexane, t-butyl-cumyl peroxide, 2,5-dimethyl-2,5-di(tert-butylperoxy)hexane, 1,3-bis(tert-butylperylperoxyisopropyl)benzene, or combinations of two or more of these. These peroxides, and others, are available under the brand name Luperox® sold by Arkema.

The foaming agent (also known as blowing agent) may be a chemical or physical agent. It is preferably a chemical agent such as for example azodicarbonamide, dinitrosopentamethylenetetramine, p-toluenesulfonyl hydrazide, p,p′-oxybis(benzenesulfonyl hydrazide), or combinations of two or more of these, or mixtures based on citric acid and sodium hydrogen carbonate (NaHCO₃) (such as the product of the Hydrocerol® range from Clariant). It may also be a physical agent, for instance dinitrogen or carbon dioxide, or a hydrocarbon, chlorofluorocarbon, hydrochlorocarbon, hydrofluorocarbon or hydrochlorofluorocarbon (saturated or unsaturated). For example, butane or pentane may be used. To adapt the expansion-decomposition temperature and the foaming processes, a foaming agent may be a mixture of (physical and/or chemical) foaming agents or of foaming agents and an activator.

According to one embodiment, when a chemical foaming agent is used, from 0.1% to 10%, or preferably from 0.1% to 5%, by weight of an activator of the foaming agent is additionally introduced into the mixture. An activator may be one or more metal oxides, metal salts or organometallic complexes, or combinations of two or more of these. Examples include ZnO, zinc stearate, MgO or combinations of two or more thereof.

The compounds may be mixed by any means known to a person skilled in the art, for example using a Banbury mixer, intensive mixers, a roll mixer, an open mill, or an extruder.

The time, temperature and shear rate can be regulated to ensure optimum dispersion without premature crosslinking or foaming. A high mixing temperature can lead to premature crosslinking and foaming as a result of decomposition of the crosslinking agents, for example peroxides, and of the foaming agents. The compounds may form a homogeneous mixture when they are mixed at temperatures of around 60° C. to around 200° C., or from 80° C. to 180° C., or from 70° C. to 150° C. or from 80° C. to 130° C. The upper temperature limit for satisfactory operation can depend on the initial decomposition temperatures of the crosslinking agents and of the foaming agents that are used.

The (co)polymers may be mixed in the molten state before being mixed with other compounds. For example, the polymers may be mixed in the molten state in an extruder at a temperature ranging up to around 250° C. to enable a good potential mixing. The resulting mixture may then be mixed with the other compounds described above.

After mixing, shaping may be carried out, by injection moulding, compression in a mould or extrusion.

The mixture may be shaped in the form of sheets, pellets or granules, with the appropriate dimensions for foaming. Roll mixers are frequently used to produce sheets. An extruder can be used to shape the composition in the form of pellets or granules.

The foaming step can be carried out in a compression mould at a temperature and for a time which make it possible to achieve decomposition of the crosslinking agents and of the foaming agents. The foaming step can be carried out during injection of the composition into the mould, and/or by opening the mould. The temperature and time applied during the foaming step can be easily regulated by a person skilled in the art to optimize foaming of the EVA and/or of ethylene and of alkyl (meth)acrylate. Alternatively, the foaming step can be carried out directly on exiting an extrusion. The resulting foam may furthermore be shaped to the dimensions of the finished products by any means known in the art such as by thermoforming and compression moulding.

It has been observed that the PEBA copolymer does not contribute to the crosslinking of the foam under these conditions, but that, unexpectedly, its presence does not hinder the formation of the crosslinked foam of the EVA and/or of ethylene and of alkyl (meth)acrylate and further provides particularly interesting properties to the foam as indicated above.

Foam and Use Thereof

The foam according to the invention preferably has a density of less than or equal to 200 kg/m³, particularly preferably less than or equal to 180 kg/m³. It may, for example, have a density of from 25 to 200 kg/m³, and more particularly preferably from 50 to 180 kg/m³, or from 50 to 160 kg/m³. The density may be controlled by adapting the parameters of the production process.

Preferably, this foam has a rebound resilience, according to the standard ISO 8307:2007, of greater than or equal to 50%, preferably greater than or equal to 55%. Generally, the resilience of the foam of the invention is less than 80%, or less than 75%, or less than 70%.

Preferably, this foam has a compression set after 30 minutes, according to the standard ISO 7214:2012, of less than or equal to 60%, preferably less than or equal to 55%, or else less than or equal to 50%.

Preferably, this foam also has excellent properties in terms of fatigue strength and dampening.

The foam of the present invention has improved resilience while still retaining appropriate stiffness and lightness, good dimensional stability and good abrasion resistance, which is particularly suitable for application in shoes.

In addition, the foam of the present invention provides better adhesion on the other elements in order to facilitate a complex assembly. This is because EVA foams are substrates that are not very polar and that adhere weakly to the other elements of the shoe, making the assembly steps complex. This is particularly interesting in the context of a shoe which is often in multilayer form.

The foam according to the invention may be used for producing sports articles, such as sports shoe soles, ski shoes, midsoles, insoles or functional sole components, in the form of inserts in the various parts of the sole (for example the heel or the arch), or shoe upper components in the form of reinforcements or inserts into the structure of the shoe upper, or in the form of protections.

It may also be used for producing balls, sports gloves (for example football gloves), golf ball components, rackets, protective elements (jackets, interior elements of helmets, shells, etc.). Typically, these articles may be produced by injection moulding or by injection moulding followed by compression moulding.

The foam according to the invention has advantageous anti-impact, anti-vibration and anti-noise properties, combined with haptic properties suitable for equipment goods. It may thus also be used for producing railway rail pads, or various parts in the motor vehicle industry, in transport, in electrical and electronic equipment, in construction or in the manufacturing industry. The invention will be further explained in a nonlimiting manner with the aid of the following Examples.

### EXAMPLES

The examples were carried out with the mixtures described in Table 1.

The EVA copolymer used is a product sold by SK Functional Polymer: Evatane® 28-05, an EVA copolymer with a vinyl acetate content of 28% by weight and a melt flow index of 5 g/10 minutes.

The copolymer of Example 1 and of Comparative Examples 2 and 3 comprises PA 6/12 blocks of number-average molar mass 1000 g/mol and PTMG blocks of number-average molar mass 1000 g/mol. The mass ratio of the polyamide blocks relative to the polyether blocks is equal to 1.

The compounds were mixed in a mixer for 10 minutes at 100° C. to form a molten mass. The mixtures were then shaped (in the form of sheets) at 95° C. using a roll mixer. The sheets obtained were then foamed by compression/moulding in a press (Darragon) for 20 minutes at 160° C.

The mechanical tests performed on the foams are as follows:
density measurement (kg/m³), according to the standard ISO 845;
hardness (Asker C),
shrinkage (%) after 1 h at 70° C.,
ball rebound resilience (%): according to the standard ISO 8307 (a 16.8 g steel ball 16 mm in diameter is dropped from a height of 500 mm onto a foam sample; the rebound resilience then corresponds to the percentage of energy returned to the ball, or percentage of the initial height reached by the ball on rebound) and
compression set (comp. set, %): a measurement is carried out consisting in compressing a sample to a given degree of deformation and for a given time, then in releasing the stress, and in noting the residual deformation after a recovery time; the measurement is adapted from the standard ISO 7214, with a deformation of 50%, a hold time of 6 h, a temperature of 50° C.

TABLE 1

| | | Comparative | Comparative | Comparative | |
|---|---|---|---|---|---|
| | Compounds | Example 1 | Example 2 | Example 3 | Example 1 |
| Polymer | EVA 28-05 | 100 | 0 | 55 | 80 |
| matrix (%) | PEBA | 0 | 100 | 45 | 20 |

| | | |
|---|---|---|
| Additives | ZnO | 2 |
| (PHR) | TiO₂ | 1 |
| | Stearic acid | 0.8 |
| | (processing aid) | |
| Crosslinking | Luperox ® DCP | 0.8 |
| agent (PHR) | (dicumyl peroxide) | |
| | (commercial product | |
| | from Arkema) | |
| Foaming | Cellcom JTR-M50N2 | 7 |
| agent (PHR) | (azodicarbonamide) | |
| | (commercial product | |
| | from Kum Yang) | |

| | | | | |
|---|---|---|---|---|
| Foamability | ∘ | x | x | ∘ |

PHR = parts per hundred of resin (unit of measurement used in formulation denoting the number of parts of a constituent per hundred parts of polymer matrix by mass).

The parameter “foamability” appearing in Table 1 denotes the capacity of the composition to repeatedly form a quality foam. It is determined according to the following criteria:
∘: good expansion of the foam in three spatial directions, dimensions of the foam preserved after cooling, fine and homogeneous cell structure,
x: weak expansion of the foam (or none at all), dimensions of the foam lost after cooling due to collapse and/or coarse and heterogeneous cell structure.

TABLE 2

| | | Comparative | |
|---|---|---|---|
| | | Example 1 | Example 1 |
| Rebound resilience | % | 50 | 53 |
| Density | kg/m³ | 210 | 192 |
| Hardness | Asker C | 44 | 44 |
| Comp. set | % (50%, 6 h) | 55 | 56 |
| Shrinkage | % (70° C., 1 h) | 5 | 2.6 |

The crosslinked EVA foam comprising 20% by weight of PEBA (Example 1) in the polymer matrix was formed homogeneously and stably. The results of the tests are repeatable (3 foams produced over 3 tests). Evaluation of the mechanical performance qualities of the foams reveals an increase in the resilience of 50% vs. 53%, a reduction in the density (210 vs. 192 kg/m³) without deterioration in the hardness or compression set, and also a reduction in shrinkage after annealing for 1 h at 70° C. In contrast, Table 1 shows that, under similar conditions, it was not possible to obtain quality foams from PEBA alone (Comparative Example 2) nor a composition comprising more than 40% by weight of PEBA in the polymer matrix (Comparative Example 3).

1. Crosslinked foam comprising:
from 30% to 99.9%, typically from 50% to 99.9%, by weight of a copolymer (a) chosen from an ethylene-vinyl acetate (EVA) copolymer, a copolymer of ethylene and of alkyl (meth)acrylate and/or mixtures thereof,
from 0.1% to 40% by weight of a copolymer (b) containing polyamide blocks and polyether blocks (PEBA copolymer),
from 0% to 50% by weight of a polyolefin (c) and/or a thermoplastic elastomeric polymer (d);
the total amounting to 100% by weight of the foam;
said foam having a density of less than or equal to 200 kg/m³, and/or a rebound resilience, according to the standard ISO 8307:2007, of greater than or equal to 50%.

2. Foam according to claim 1, wherein the mass ratio of the polyamide blocks relative to the polyether blocks of the copolymer (b) is from 0.3 to 5.

3. Foam according to claim 1, comprising from 0.1% to 20% by weight of additives, relative to the total weight of the foam.

4. Foam according to claim 1, wherein the polyolefin (c) is a functionalized polyolefin (c1).

5. Foam according to claim 4, comprising from 0.1% to by weight, relative to the total weight of the foam, of the polyolefin (c).

6. Foam according to wherein claim 1, the thermoplastic elastomeric polymer (d) is chosen from a copolymer containing polyester blocks and polyether blocks, a thermoplastic polyurethane, an olefinic thermoplastic elastomer or an olefinic block copolymer, a styrene-diene block copolymer, and/or mixtures thereof.

7. Foam according to claim 1, wherein the polyamide blocks of the copolymer (b) comprise polyamide blocks chosen from PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, PA 6/12, PA 11/12, PA11/10.10, or mixtures or copolymers thereof.

8. Foam according to claim 1, wherein the polyether blocks of the copolymer (b) are chosen from PEG blocks, and/or PPG blocks, and/or PO3G (polytrimethylene glycol) blocks and/or PTMG blocks.

9. Foam according to claim 1, wherein the number-average molecular mass Mn of the polyamide blocks is between 400 and 13,000 g/mol, and the number-average molecular mass Mn of the polyether blocks is between 100 and 3000 g/mol.

10. Process for preparing a foam according to claim 1, comprising:
(i) a step of providing a mixture comprising:
from 30% to 99.9% by weight of a copolymer (a),
from 0.1% to 40% by weight of a copolymer (b),
from 0.01% to 2% by weight of a crosslinking agent,
from 0.5% to 10% by weight of a foaming agent,
from 0% to 50% by weight of a polyolefin (c) and/or a thermoplastic elastomeric polymer (d), and from 0% to 20% by weight of at least one additive,
the total amounting to 100% by weight of the mixture;
(ii) a step of shaping the mixture by injection moulding, compression/moulding or extrusion; and
(iii) a step of foaming the mixture.

11. Foam capable of being obtained according to the process of claim 10.

12. Article, comprising at least one element consisting of a foam according to claim 1.

13. Article according to claim 12, which is chosen from shoe soles, large or small balls, gloves, personal protective equipment, rail pads, motor vehicle parts, construction parts and electrical and electronic equipment parts.
